(19) United States
(12) Patent Application Publication
(10) Pub. No.: US 2012/0131556 A1
(43) Pub. Date: May 24, 2012

(54) XPATH-BASED SELECTION ASSISTANCE OF GUI ELEMENTS DURING MANUAL TEST SCRIPT AUTHORING FOR XML-BASED APPLICATIONS

(75) Inventors: ASHISH K. MATHUR, BANGALORE (IN); ASWANI KUMAR THUNGA, BANGALORE (IN)

(73) Assignee: INTERNATIONAL BUSINESS MACHINES CORPORATION, ARMONK, NY (US)

(21) Appl. No.: 12/950,176

(22) Filed: Nov. 19, 2010

(51) Int. Cl. G06F 9/44

(52) U.S. Cl. 717/125

(57) ABSTRACT

An automated software testing system can include a test script authoring graphical user interface and an element selection assistant. The test script authoring graphical user interface is an interface for manual test script authoring of an XML representation of a GUI for software applications formed from one or more XML based source code documents. A search section is a user input section within which a user is permitted to input at least one of an XPATH expression and a text string. The element selection assistant can be for searching the XML-based code documents using a search XPATH expression. The search XPATH expression can be the XPATH expression input into the search section or a generated XPATH expression automatically generated from the text string. The result section can present results from the element selection assistant.

### BACKGROUND

The present invention relates to the field of software testing and, more particularly, to the XPATH-based selection assistance of GUI elements during manual test script authoring for XML-based applications.

An automated software testing system is a common tool utilized in the software development process. An automated software testing system provides a graphical means in which a test script can be generated for a software application, often referred to as an application under test (AUT). Typically, an automated software testing system generates test scripts from either a recording of a user interacting with a graphical user interface (GUI) of an AUT or the manual entry of steps.

The automatic generation of a test script from a recording is quite a timesaver for large and/or complex software applications. However, for small applications like Web applications, manual authoring is often simpler with a knowledgeable user. Unfortunately, many conventional automated software testing systems do not take advantage of the functions or capabilities available with respect to the extensible markup language (XML) based languages that many Web application are written.

For example, XPATH is a query language capable of querying many XML-based languages. Conventional automated software testing system lack tools that support the use of XPATH to search source code to identify the elements that the user wants to use in the test script.

### BRIEF SUMMARY

One aspect of the disclosure provides an automated software testing system comprising a test script authoring graphical user interface, a search section and a result section of a graphical user interface, and an element selection assistant. The test script authoring graphical user interface is an interface for manual test script authoring of an XML-based software application formed from one or more XML based source code documents. The search section is a user input section within which a user is permitted to input at least one of an XPATH expression and a text string. The element selection assistant can be for searching the XML-based code documents for graphical user interface elements using a search XPATH expression. The search XPATH expression can be the XPATH expression input into the search section or a generated XPATH expression automatically generated from the text string. The result section can present results from the element selection assistant. The results can comprise all graphical user interface elements in the searched XML-based code documents matching criteria of the search XPATH expression.

Another aspect of the disclosure provides a method, system, and computer program product for augmenting manual test script authoring. In this aspect, a software application associated with a test script can be presented within a user interface of an automated software testing system. The software application can be written in a language based upon an extensible markup language (XML) supporting use of an XPATH query language. User entered search data can be received via an element selection assistant interface associated with the element selection assistant. At least one source code file associated with the software application can be queried using the user-entered search data. Results of the querying of the at least one source code file can be presented within the element selection assistant interface.

### BRIEF DESCRIPTION OF THE SEVERAL VIEWS OF THE DRAWINGS

FIG. 1 is a schematic diagram illustrating a system that utilizes an element selection assistant for manual test script authoring in accordance with embodiments of the inventive arrangements disclosed herein.

FIG. 2 is a collection of example graphical user interfaces (GUIs) illustrating functionality of the element selection assistant interface and element selection assistant in accordance with an embodiment of the inventive arrangements disclosed herein.

FIG. 3 is a flow chart of a method describing the general operation of the element selection assistant in accordance with an embodiment of the inventive arrangements disclosed herein.

FIG. 4 is a flow chart of a method detailing additional selection assistance provided by the element selection assistant for XPATH expression searches in accordance with embodiments of the inventive arrangements disclosed herein.

### DETAILED DESCRIPTION

The present invention discloses a solution that utilizes the XPATH query language to assist in the selection of GUI elements when authoring a test script for an XML-based software application. An automated software testing system can utilize an element selection assistant component to provide support for functionality that allows a user to search for and/or select GUI elements during manual creation of a test script. The user can enter a text string or XPATH expression that the element selection assistant can use to query the XML-based source code for the software application associated with the test script. Results of the query can be accentuated in the GUI of the software application by the element selection assistant.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

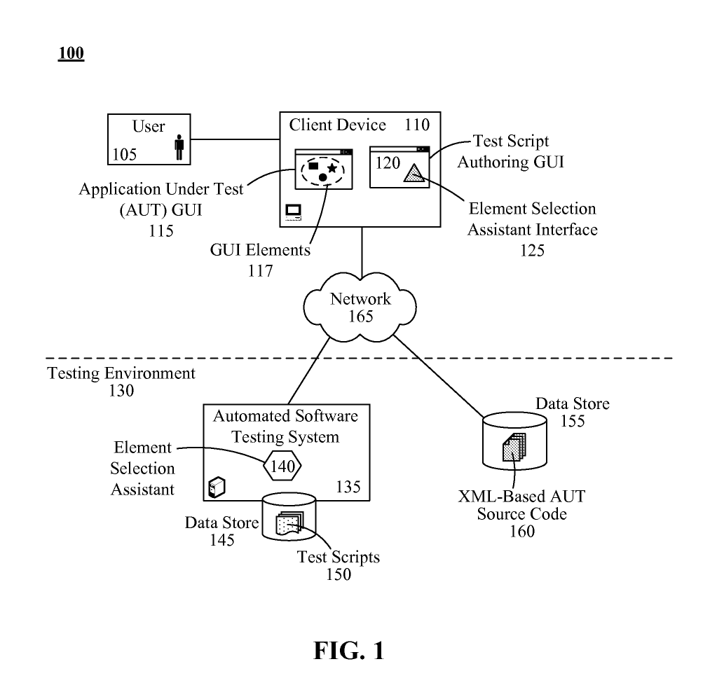

FIG. 1 is a schematic diagram illustrating a system 100 that utilizes an element selection assistant 140 for manual test script 150 authoring in accordance with embodiments of the inventive arrangements disclosed herein. In system 100, a user 105 can receive assistance selecting GUI elements 117 of a graphical user interface (GUI) 115 for an application under test (AUT) from the element selection assistant 140 when manually authoring a test script 150.

The user 105 can create the test script 150 using a test script authoring GUI 120 associated with an automated software testing system 135. A test script 150 can represent a series of executable steps that the user 105 would take to perform a specific set of actions (i.e., use case) within the AUT GUI 115.

The test script 150 can be performed by the automated software testing system 135 on the AUT in a testing environment 130. The testing environment 130 can represent a computing environment, hardware and/or software, designed to support the testing of software applications (AUTs). A testing environment 130 can be separated from an organization's production (i.e., operating) computing environment.

An AUT can represent the specific software application whose operation is being evaluated by an automated software testing system 135 in the testing environment 130 via the test script 150. As with any software application, the AUT can be represented by one or more source code 160 files that define the AUT GUI 115 and underlying functions.

Specifically, this embodiment of the present disclosure can pertain to AUTs (and AUT GUIs 115) written using extensible markup language (XML) based languages (e.g., XFORMS, extensible hypertext markup language (XHTML), XQUERY, web services definition language (WSDL), etc.). It should be noted that generally, while the AUT GUI 115 may be represented in an XML format, the AUT itself may be coded in another language, such as Java, Windows 32, etc. In this particular embodiment, however, the source code 160 for the AUT can be represented by a set of XML-based files having the appropriate file extension.

As such, the source code 160 for the AUT used in system 100 need not require compilation prior to execution and can be directly rendered by an appropriate interpreter application (i.e., Web browser) on the user's 105 client device 110. The XML-based AUT source code 160 can be maintained in a data store 155 within the testing environment 130 that is accessible by the user's 105 client device 110 and the automated software testing system 135.

In another embodiment, the data store 155 housing the XML-based AUT source code 160 can be associated with a configuration management (CM) system, requiring authentication by the user 105 and/or automated software testing system 135 for access. In another contemplated embodiment, the data store 155 containing the XML-based AUT source code 160 can be associated with another type of server (e.g., file server, data server, Web server) within the testing environment 130.

The AUT GUI 115 defined in the XML-based AUT source code 160 can include a variety of GUI elements 117. The GUI elements 117 can represent the graphical portions of the AUT GUI 115 that the user 105 can interact with, such as tabs, buttons, and text fields, as supported by the specific language in which the AUT is written.

The automated software testing system 135 can represent the hardware and/or software components required to execute test scripts 150 upon the AUT (and the AUT GUI 115). The test scripts 150 can be contained in a data store 145 component of the automated software testing system 135. In an alternate embodiment, data store 145 can be remotely located to, yet accessible by the automated software testing system 135.

The user 105 can interact with the automated software testing system 135 over network 165 using GUIs designed for specific purposes. This embodiment of the present disclosure can utilize the test script authoring GUI 120 of the automated software testing system 135.

The test script authoring GUI 120 can represent the interface in which the user 105 can manually define the contents of the test script 150, as opposed to utilizing a GUI that generates the test script 150 based upon a recording of the user's 105 interaction with the AUT GUI 115. Thus, the user 105 can manually enter and/or select steps to comprise the test script 150.

Conventional approaches to test script authoring GUIs 120 can require the user 105 to have intimate knowledge of how the GUI elements 117 are expressed in the source code 160. For example, the user 105 may need to know the unique identifier for a GUI element 117 in a specific AUT GUI 115.

This situation can be further complicated when similarly-named GUI elements 117 exist and/or the same type of GUI element 117 exists in multiple AUT GUIs 115. For example, the AUT can contain GUIs A and B 115, each having a submit button 117. When writing a step in the test script 150 to reference the submit button 117 in GUI B 115, the user 105 may need to take additional steps (i.e., check the XML-based AUT source code 160) to ensure that the identifier for the submit button 117 in GUI A 115 is not used by accident, and vice versa.

In another example, the identifiers for text fields 117 collecting the name of the user 105 and their organization can differ by one character (e.g., frame, mname, lname, and oname). As such, the proximity of the keyboard keys for the letters l, m, and can easily cause typographical errors that the automated software testing system 135 may not recognize as errors, since GUI elements 117 exist with those identifiers.

These issues can impede the user's 105 ability to efficiently and effectively author test scripts 150, requiring additional time and coordination to ensure accuracy. The automated software testing system 135 of system 100 can address such issues through the use of the element selection assistant 140.

The element selection assistant 140 can represent a software component of the automated software testing system 135 configured to assist the user 105 in the selection of GUI elements 117 in the AUT GUI 115 when creating a test script 150 in the test script authoring GUI 120. The user 105 can access the functionality of the element selection assistant 140 using the element selection assistant interface 125.

In a contemplated embodiment, the element selection assistant 140 can be implemented as a plug-in component of the automated software testing system 135, such as a plug-in for use with the RATIONAL QUALITY MANAGER, RATIONAL FUNCTIONAL TESTER, and/or RATIONAL MANUAL TESTER. In another embodiment, the element selection assistant 140 can be an integrated function of the automated software testing system 135.

In yet another embodiment, the element selection assistant 140 can be a software application external to the automated software testing system 135, though capable of interacting with the test script authoring GUI 120, automated software testing system 135, and AUT GUI 115.

The element selection assistant interface 125 can allow the user 105 a mechanism for identifying GUI elements 117 for use in the test script 150 being created in the test script authoring GUI 120. The element selection assistant interface 125 can be presented to the user 105 directly within the test script authoring GUI 120 or in a separate window, depending upon implementation.

Also, dependent upon implementation, the element selection assistant interface 125 can be manually invoked by the user 105 from within the test script authoring GUI 120 (i.e., menu command or button) or a mechanism external to the test script authoring GUI 120 (i.e., application icon) or can be automatically initiated when the test script authoring GUI 120 is invoked.

The element selection assistant interface 125 can also include a mechanism to allow the user 105 to directly insert the reference or identification of a resultant GUI element 117 into the test script 150 within the test script authoring GUI 120.

The identification of the GUI elements 117 by the element selection assistant 140 can be based upon a text string entered by the user 105 into the element selection assistant interface 125. For example, the user 105 can search the XML-based AUT source code 160 for GUI elements 117 that correspond to the text string, “checkbox”.

The element selection assistant 140 can translate the entered text string into a path expression written in the XPATH query language. Alternately, the text string entered by the user 105 can have the form of an XPATH path expression. The entered or convert path expression can be executed to identify matching nodes of the XML-based AUT source code 160.

Further, the element selection assistant interface 125 can provide additional selection assistance to the user 105 based upon the entered path expression. For example, the element selection assistant 140 can suggest the use of parent and/or child nodes to help the user 105 broaden or narrow the path expression.

In another embodiment, the selection assistance provided for a path expression can occur in near real-time, as the user 105 enters the path expression into the element selection assistant interface 125.

The element selection assistant 140 can provide additional feedback to the user 105 during the authoring process by highlighting or accentuating the resultant GUI elements 117 within the AUT GUI 115. Using the previous example, checkbox GUI elements 117 of the AUT GUI 115 that correspond to the results of the user's 105 search can be visually accentuated.

Accentuation of the GUI elements 117 can be achieved in a variety of manners consistent with the language of the AUT GUI 115 and support provided by the automated software testing system 135 and/or user's 105 client device 110. For example, the automated software testing system 135 can create a temporary copy of the XML-based AUT source code 160 for the AUT GUI 115 and insert additional code and/or attribute values to create colored boxes around the corresponding GUI elements 117.

The client device 110 utilized by the user 105 can represent a variety of computing devices capable of supporting operation of the AUT GUI 115, the test script authoring GUI 120, and element selection assistant interface 125, as well as communicating over network 165 with the data store 155 housing the XML-based AUT source code 160 and automated software testing system 135.

Network 165 can include any hardware/software/and firmware necessary to convey data encoded within carrier waves. Data can be contained within analog or digital signals and conveyed though data or voice channels. Network 165 can include local components and data pathways necessary for communications to be exchanged among computing device components and between integrated device components and peripheral devices. Network 165 can also include network equipment, such as routers, data lines, hubs, and intermediary servers which together form a data network, such as the Internet. Network 165 can also include circuit-based communication components and mobile communication components, such as telephony switches, modems, cellular communication towers, and the like. Network 165 can include line based and/or wireless communication pathways.

As used herein, presented data stores 145 and 155 can be a physical or virtual storage space configured to store digital information. Data stores 145 and 155 can be physically implemented within any type of hardware including, but not limited to, a magnetic disk, an optical disk, a semiconductor memory, a digitally encoded plastic memory, a holographic memory, or any other recording medium. Data stores 145 and 155 can be stand-alone storage units as well as a storage unit formed from a plurality of physical devices. Additionally, information can be stored within data stores 145 and 155 in a variety of manners. For example, information can be stored within a database structure or can be stored within one or more files of a file storage system, where each file may or may not be indexed for information searching purposes. Further, data stores 145 and/or 155 can utilize one or more encryption mechanisms to protect stored information from unauthorized access.

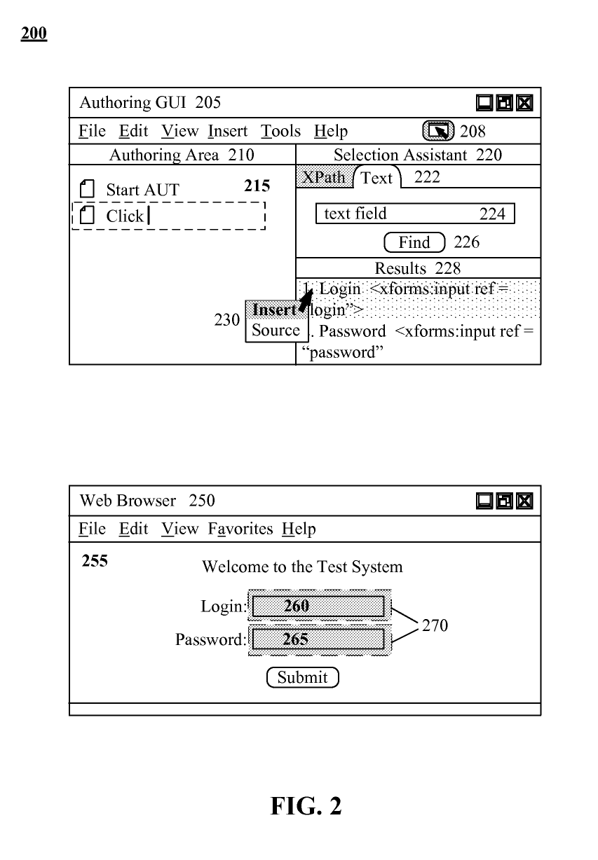

FIG. 2 is a collection 200 of example graphical user interfaces (GUIs) 205 and 255 illustrating functionality of the element selection assistant interface and element selection assistant in accordance with embodiments of the inventive arrangements disclosed herein. The GUIs 205 and 255 of collection 200 can utilized within the context of system 100 or any other automated software testing system configured to utilize a element selection assistant for selecting GUI elements of XML-based software applications during manual creation of test scripts.

Authoring GUI 205 can represent the user interface of an automated software testing system used by a user to manually create a test script, such as the test script authoring GUI 120 of system 100. Authoring GUI 205 can include an authoring area 210 and space for the selection assistant 220 user interface.

It should be noted that the elements presented in authoring GUI 205 are for illustrative purposes only, and are not intended as an absolute embodiment of the present disclosure.

The authoring area 210 can represent the portion of the authoring GUI 205 in which the user can enter textual expressions 215 for the test script. In this example, the authoring area 210 can be similar to the AUTHORING EDITOR utilized by the RATIONIAL MANUAL TESTER.

The textual expressions 215 entered in the authoring area 210 can represent the steps or actions to be performed by the automated software testing system upon the application under test (AUT). The syntax and semantics utilized for the textual expressions 215 can be dependent upon the automated software testing system to which the authoring GUI 205 belongs. Typically, a textual expression 215 can include elements that correspond to actions and identifiers for target objects like GUI elements and files.

The selection assistant 220 can represent the user interface for the element selection assistant like the element selection assistant interface 125 of system 100. In this example, the selection assistant 220 can share window space with the authoring area 210 in the authoring GUI 205.

In an alternate embodiment, the selection assistant 220 can be presented in a window separate to the authoring GUI 205.

The selection assistant 220 can include a search area 222 and a results area 228. The search area 222 can represent the portion of the selection assistant 220 where the user can enter and execute searches for GUI elements in the AUT.

The search area 222 can be implemented in a variety of manners. In this example, the search area 222 can utilize a tab structure to allow the user to change between searching the AUT source code using an XPATH path expression or a text string.

This example can illustrate the capture of text string input in the search area 222. The user can input a text string, “text field” in this example, into a text field 224 and select the find button 226.

The element selection assistant can then query the source code corresponding to the AUT for which the test script is being written using the contents of the text field 224. When handling text strings, the element selection assistant can be configured with logic that translates the text string into an equivalent XPATH expression that can be used with the XML-based language in which the AUT is written.

For example, when using the text string, “text field”, the element selection assistant can generate an XPATH expression to search for un-typed input tags for an AUT written in XFORMS. However, for an AUT written in XHTML, the element selection assistant can generate an XPATH expression to search for input tags having a type attribute set to “text”.

The results area 228 can list the results of the query executed by the element selection assistant for the criteria specified in the search area 222. The information shown in the results area 228 can vary depending upon implementation. In this example, the results area 228 can list the name and corresponding XFORMS tag for each result.

In addition to listing the resultant elements in the results area 228, the element selection assistant can also provide visual identification of the resultant elements in the AUT GUI 255. The AUT GUI 255 can represent a rendering of the XML-based source code for the GUI of the AUT containing the resultant elements.

In this example, the source code of the AUT can correspond to an XFORMS form and can be rendered within a Web browser 250. The resultant elements for the “text field” search shown in the results area 228 can correspond to the two text fields 260 and 265 of the AUT GUI 255 presented in the Web browser 250. Each text field 260 and 265 can have an accentuation 270, illustrated as a shaded dashed box in this example.

In the event that the user is not currently displaying the AUT GUI 255, the element selection assistant can be configured to automatically present the appropriate GUI 255 of the AUT associated with the test script in the authoring GUI 205.

Further, the user can select an element listed in the results area 228. Depending upon implementation and design, the selection of an element in the results area 228 can precipitate a change in the accentuation 270 of GUI elements in the AUT GUI 255.

For example, when the user selects the first element in the results area 228, denoted by light shading, the accentuation 270 in the AUT GUI 255 can change to exclude the accentuation 270 of the password text field 265.

Additionally, the selection assistant 220 can provide the user with operations that can be performed upon a selected element of the results area 228. For example, right-clicking on a selected element can result in the presentation of a context menu 230.

The context menu 230 can include commands that the user can execute in relation to the authoring GUI 205 and/or automated software testing system. In this example, the context menu 230 contains a command to insert the appropriate information for the selected element into the current step of the authoring area 210, as indicated by the dashed box, and a command to present the source document of the selected element.

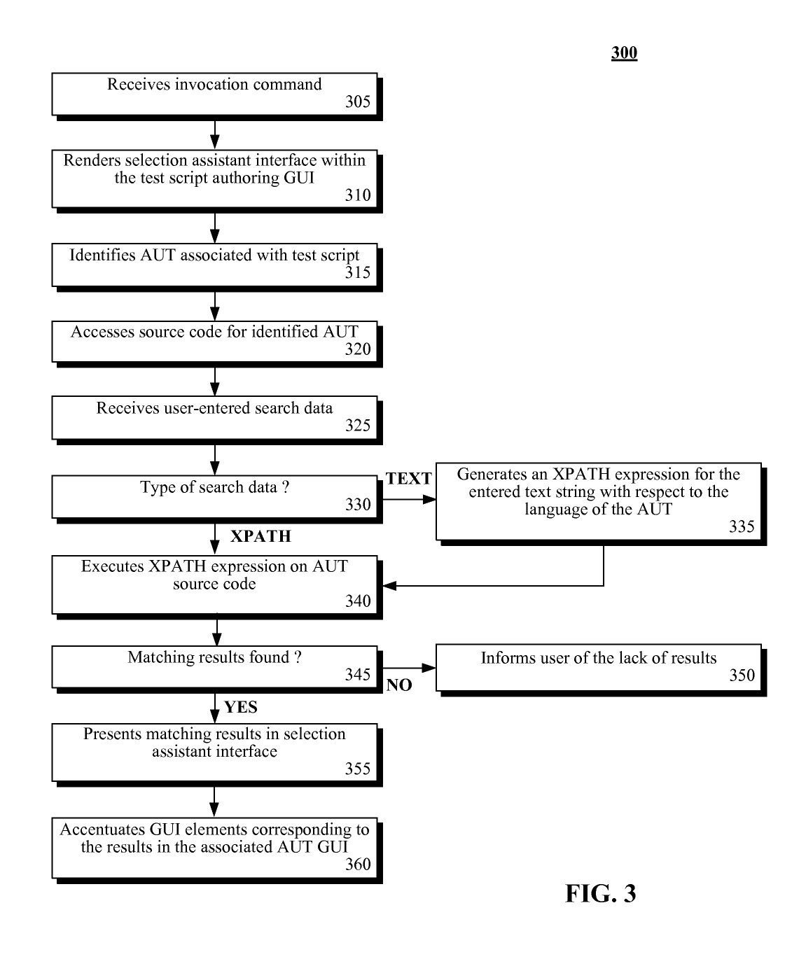

FIG. 3 is a flow chart of a method 300 describing the general operation of the element selection assistant in accordance with embodiments of the inventive arrangements disclosed herein. Method 300 can be performed within the context of system 100 and/or utilizing the GUIs of collection 200.

Method 300 can begin in step 305 where the element selection assistant can receive an invocation command. The invocation command can be provided manually by a user or automatically via the automated software testing system.

The selection assistant interface can be rendered within the test script authoring GUI in step 310. As previously stated, the selection assistant interface can also be rendered external to the test script authoring GUI.

In step 315, the element selection assistant can identify the AUT for which the test script is being created. The source code for the identified AUT can be accessed in step 320. In step 325, user-entered search data can be received via the selection assistant interface. The type of received search data can be determined in step 330.

When the received search data is a text string, flow of method 300 can divert to step 335 where the element selection assistant can generate an XPATH expression for the entered text string with respect to the language in which the AUT is written. When the received search data is an XPATH expression or upon completion of step 335, the XPATH expression can be executed upon the AUT source code in step 340.

In step 345, it can be determined if results matching the XPATH expression were found. When matching results are not found, step 350 can execute where the element selection assistant informs the user of the lack of results.

When matching results are found, the matching results can be presented to the user in the selection assistant interface in step 355. In step 360, the GUI elements corresponding to the matching results can be accentuated in the associated AUT GUI.

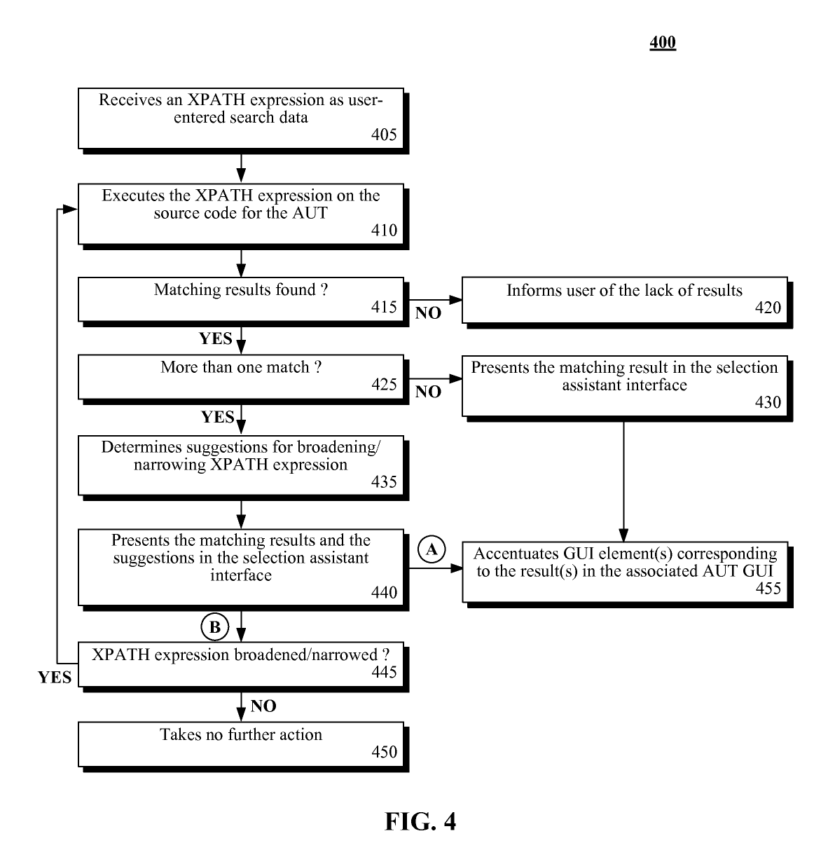

FIG. 4 is a flow chart of a method 400 detailing additional selection assistance provided by the element selection assistant for XPATH expression searches in accordance with embodiments of the inventive arrangements disclosed herein. Method 400 can be performed within the context of system 100, utilizing the GUIs of collection 200, and/or in conjunction with method 300.

Method 400 can begin in step 405 where the element selection assistant can receive an XPATH expression as user-entered search data. The XPATH expression can be executed upon the source code for the AUT in step 410. In step 415, it can be determined if results matching the XPATH expression exist.

When matching results are not found, step 420 can execute where the element selection assistant can inform the user of the lack of results. When matching results are found, it can be determined if the set of matching results contains more than one match in step 425.

When the set of matching results does not contain more than one result (i.e., exactly one matching result exists), step 430 can execute where the matching result can be presented in the selection assistant interface. From step 430, the GUI element corresponding to the result can be accentuated in the associated AUT GUI upon execution of step 455.

When the set of matching results contains more than one match, the element selection assistant can determine suggestions for broadening and/or narrowing the scope of the XPATH expression in step 435. For example, the element selection assistant can identify the parent and/or child nodes for the nodes contained in the results.

In step 440, the matching results and the determined suggestions can be presented to the user in the selection assistant interface. From step 440, method 400 can split into two paths A and B that can occur simultaneously, each path focusing on a different task.

Path A can flow to step 455 where the GUI elements corresponding to the results can be accentuated in the associated AUT GUI. Path B can focus upon the selection assistant interface, determining if the XPATH expression has been broadened or narrowed (i.e., the user selected a suggestion in the selection assistant interface) in step 445.

When the XPATH expression is modified, flow of method 400 can return to step 410 so the modified XPATH expression can be executed upon the AUT source code. When the XPATH expression is not modified, the element selection assistant can take no further action in step 450.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

1. An automated software testing system comprising:
a test script authoring graphical user interface for manual test script authoring of an XML-based software application formed from one or more XML based source code documents;
a search section of a graphical user interface within which a user is permitted to input at least one of an XPATH expression and a text string;
an element selection assistant for searching the XML-based code documents for graphical user interface elements using a search XPATH expression, wherein said search XPATH expression is one of the XPATH expression input into the search section and a generated XPATH expression automatically generated from the text string; and
a result section of the graphical user interface configured to present results from the element selection assistant, wherein said results comprise all graphical user interface elements in the searched XML-based code documents matching criteria of the search XPATH expression.

2. The automated software testing system of claim 1, wherein said search section of the graphical user interface is a section for which the user is prompted to input the XPATH expression, wherein the search XPATH expression is the XPATH expression input into the search section.

3. The automated software testing system of claim 1, wherein said search section of the graphical user interface is a section for which the user is prompted to input a text string, wherein the generated XPATH expression is automatically generated from the text string input into the search section, wherein the search XPATH expression is the generated XPATH expression.

4. The automated testing system of claim 1, wherein said search section comprises at least two different user input sections, comprising an XPATH input section and a text input section, wherein a user inputs the search XPATH expression in the XPATH input section and wherein the user inputs the text string from which the generated XPATH expression is automatically generated using the text input section.

5. The automated testing system of claim 1, wherein the graphical user interface in which the search section and the result section is part of the test script authoring graphical user interface.

6. The automated testing system of claim 1, further comprising:
an application window within which the XML-based software application is presented, which results from interpreting the one or more XML based source code documents, wherein the application window is linked to the graphical user interface within which code elements of the XML-based source code documents are presented, wherein GUI elements presented in the application window that correspond to GUI elements in the presented results of the result section are presented within the application window in a visually distinctive manner.

7. The automated testing system of claim 6, wherein the visually distinctive manner highlights, adjusts a foreground color of, or adjusts a background color of each GUI element presented in the application window having a corresponding GUI element listed in the result section.

8.-15. (canceled)

16. A computer program product for augmenting manual test script authoring, the computer program product comprising a computer readable storage medium having computer usable program code embodied therewith, the computer usable program code comprising:
computer usable program code stored on a storage medium that when executed by a processor is operable to determine of a software application associated with a test script presented within a user interface of an automated software testing system by an element selection assistant, wherein said software application is written in a language based upon an extensible markup language (XML) supporting use of an XPATH query language;
computer usable program code stored on a storage medium that when executed by a processor is operable to receive user-entered search data via an element selection assistant interface associated with the element selection assistant;
computer usable program code stored on a storage medium that when executed by a processor is operable to query at least one source code file associated with the software application using the user-entered search data; and
computer usable program code stored on a storage medium that when executed by a processor is operable to present within the element selection assistant interface results of the querying of the at least one source code file.

17. The computer program product of claim 16, further comprises:
computer usable program code stored on a storage medium that when executed by a processor is operable to determine a data type of the user-entered search data, wherein the data type is one of a text string data type and an XPATH expression data type;
computer usable program code stored on a storage medium that when executed by a processor is operable to, when the data type is determined to be the text string data type, convert the search data to the XPATH expression data type, wherein an XPATH expression representing the converted search data is in accordance with a syntax utilized by the XML-based language in which the software application is written.

18. The computer program product of claim 16, wherein further comprises:
computer usable program code stored on a storage medium that when executed by a processor is operable to present of the element selection assistant interface by an element selection assistant in conjunction with a user interface of an automated software testing system designed for a manual authoring of a test script for a specified application under test (AUT).

19. The computer program product of claim 16, further comprising:
computer usable program code stored on a storage medium that when executed by a processor is operable to interpret the at least one source code file; and
computer usable program code stored on a storage medium that when executed by a processor is operable to present an application user interface generated from the interpreted at least one source code file within a screen, wherein the application user interface is programmatically linked to the results of the element selection assistant interface such that GUI elements present in the results of the element selection assistant interface are presented within the application user interface in a visually distinctive manner.

20. The computer program product of claim 19, wherein the visually distinctive manner highlights, adjusts a foreground color of, or adjusts a background color of each GUI element presented in the application window having a corresponding GUI element listed in the result section.
